(19) United States
(12) Patent Application Publication
(10) Pub. No.: US 2014/0266631 A1
(43) Pub. Date: Sep. 18, 2014

(54) Using a Communication Protocol to Provide Security Services

(71) Applicant: Kelan C. Silvester, Portland, OR (US)

(72) Inventor: Kelan C. Silvester, Portland, OR (US)

(21) Appl. No.: 14/287,427

(22) Filed: May 27, 2014

Related U.S. Application Data
(62) Division of application No. 09/974,923, filed on Oct. 10, 2001.

(51) Int. Cl. G08C 17/02

(52) U.S. Cl. CPC G08C 17/02; G08C 2201/60
USPC 340/10.5

(57) ABSTRACT

A wireless communication protocol may be utilized to authenticate a protected device. If the device is not properly authenticated, the device may be rendered inoperable. Thus, a limited range RF communication between the protected device and a base station may be utilized to automatically determine whether or not the device may be utilized. If the base station is not in-range, operation of the device may be defeated.

### CROSS-REFERENCE TO RELATED APPLICATIONS

This application is a divisional of U.S. patent application Ser. No. 09/974,923, filed on Oct. 10, 2001.

### BACKGROUND

This invention relates generally to techniques for preventing the theft of any of a variety of devices.

A variety of portable devices are subject to theft. Common examples are laptop computers, automotive electronics, desktop computers, home entertainment equipment, such as televisions, and a variety of other items. Generally, any theft deterrent that results in greater inconvenience to the user often goes unused.

A variety of locks and other security devices are available for computers, but generally, relatively few people use these security devices. It is believed that the lack of utilization of these devices is not the result of the lack of sufficient need to do so, but arises from the inconvenience involved in applying the security device.

Thus, there is a need for a security system that deters theft while reducing the amount of user involvement necessitated by the security system.

### BRIEF DESCRIPTION OF THE DRAWINGS

Some embodiments are described with respect to the following figures:

FIG. 1 is a block depiction of one embodiment of the present invention;

FIG. 2 is a flow chart for software in accordance with one embodiment of the present invention;

FIG. 3 is a flow chart for software in accordance with one embodiment of the present invention;

FIG. 4 is a schematic depiction of another embodiment of the present invention;

FIG. 5 is a schematic depiction of still another embodiment of the present invention;

FIG. 6 is a schematic depiction of yet another embodiment of the present invention; and

FIG. 7 is a schematic depiction of still another embodiment of the present invention.

### DETAILED DESCRIPTION

Referring to FIG. 1, a radio frequency protected device 14 may be coupled through a radio frequency protocol to a short-range radio frequency base station 12. The base station 12 may in turn be coupled to a system 32, which is necessary for the operation of the protected device 14. The protected device 14 may be any of a variety of devices subject to theft including an automotive radio, a personal computer, a laptop computer, home electronics, a weapon, or a cash register, to mention a few examples. The radio frequency protocol between the protected device 14 and the base station 12 may be any of a variety of relatively short-range (e.g., 10 meters) protocols including the Bluetooth Protocol (Specification of the Bluetooth System, Version 1.1, Feb. 22, 2001).

Alternatively, longer range protocols may be used if it is acceptable to allow the protected device 14 to be operated in a wider area. For example, IEEE 802.11 wireless local area network has a range of 100 meters. See IEEE Standard 802.11 available from the Institute of Electrical and Electronics Engineers, New York, N.Y.

The protected device 14 may include a controller 26 coupled to a storage device 28. In one embodiment, the storage device 28 may be a flash memory. The storage device 28 may store software 30. A radio frequency interface 24 facilitates communications between the device 14 and the base station 12.

The base station 12 likewise includes a controller 18 coupled to an interface 16 and a storage device 20. The storage device 20 may also be a flash memory, in one embodiment. The storage device 20 stores the software 22.

The controller 18 facilities communications between the device 14 and the system 32 in one embodiment. In other words, the base station 12 enables communications between the device 14 and components, devices or systems that are necessary for full operation of the device 14. For example, in connection with a protected device 14 that is a laptop computer, the short-range radio frequency base station 12 may provide the link to an electrical system. Without the correct communication with the base station 12 through the radio frequency protocol, electrical power would not be supplied to the protected device 14, as one example. As another example, the base station 12 may only allow a user to access stored data after being properly authenticated through the wireless protocol. As still another example, the base station 12 may prevent booting unless the user is properly authenticated. Alternatively, the base station 12 may allow a limited boot, for example, sufficient to send a wireless message indicating an unauthorized user is attempting to use the system.

As a result, the proper establishment of radio frequency communications between the device 14 and the base station 12 is essential to the ability to use the device 14. The device 14 can not be effectively used without likewise obtaining the base station 12. The base station 12 may be secured in a fashion that makes it more difficult to remove. In some embodiments, one base station 12 may secure a number of protected devices 14. Thus, in one example, a laptop computer may be the protected device 14 and the base station 12 may be secured to a building.

If the protected device 14 is moved outside the range of the base station 12, it may no longer be operable in some embodiments. Thus, the system 32 may be the electrical system that provides power to the device 14 as one example. Only when the proper radio frequency (RF) protocol is authenticated is the system 32 notified by the base station 12 to provide essential services for the use of the protected device 14.

Referring to FIG. 2, the software 22 in the base station 12 receives a handshake signal from a proximate wireless device, as indicated in block 32. The proximate wireless device may be an appropriate, authorized RF protected device 14. Upon receiving the handshake signal from the proximate wireless device, the base station 12 may request an identifier, as indicated in block 34. In block 36 an identifier is received from the proximate device. If the identifier is authenticated by the base station 12, as indicated in diamond 38, communication or operation with the system 32 may be allowed, as indicated in block 40, enabling the device 14 to be utilized. Otherwise, the device 14 may not be utilized or communications may be prohibited, as indicated in block 42.

In accordance with an embodiment in which the radio frequency protocol between the base station 12 and the device 14 is the Bluetooth Protocol, the device 14 may automatically implement the inquiry mode. In the inquiry mode, the device 14 attempts to determine what access points are within range. In-range devices, such as the base station 12, respond with their addresses and the device 14 selects one of the responding devices with which to communicate. To establish communications, a paging mode is implemented wherein the devices 12 and 14 synchronize with one another. Then, the devices undergo the service discovery mode wherein the device 14 discovers what services are available from the base station 12. Thereafter, communication may be implemented followed by the authentication protocol described previously.

Referring to FIG. 3, the software 30 on the protected device generates a handshake signal, as indicated in block 48. When it receives a response, as determined in diamond 50, from the base station 12, it provides the requested identifier, as indicated in block 52.

Embodiments of the present invention are amenable to a wide variety of applications. For example, in FIG. 4, the RF protected device 14 may be a car radio 14a. The radio 14a may communicate with a short-range RF base station 12 secured within a vehicle. For example, the base station 12 may be inside the dashboard or in a relatively difficult to access location. The short-range RF base station 12 may only allow communication between the radio 14a and the electrical system 32a when the radio 14a is properly authenticated. For example, electrical communication may be switched off until such time as proper authentication is received from the incoming car radio 14a. Thus, if one were to steal the car radio 14a, it would not work in any other vehicle without the base station 12. This would deter theft, increasing the value of the car radio 14a. As another example, the radio 14a may generate static or obnoxiously altered sounds if proper authentication is not achieved.

Referring to FIG. 5, an embodiment is depicted in which a personal computer 14b is the RF protected device 14. In this case, the personal computer 14b may communicate with a short-range RF base station 12 that may be concealed, for example, within the user's desk. For example, the base station 12 may control the power to the personal computer 14b. In one embodiment, the base station 12 may communicate wirelessly with an appropriate switch within the personal computer 14b to allow the computer to receive power.

Referring to FIG. 6, a laptop computer 14c may communicate with a short-range compact RF base station 12a that may be in the form of a key fob in one embodiment. The computer 14c is only operaable when the base station 12a, carried by the user, is in range. Again, the base station 12a may provide selective operation of a power control 32b to allow the laptop computer 14c to be operated.

As still another example, referring to FIG. 7, a home electronics device 14d may be a television, a stereo, or a digital versatile disk player. The device 14d may communicate with a base station 12 that provides selective control through access to the power control module 32b. Unless the electronics device 14d is properly authenticated, the base station 12 does not permit power to be applied to the home electronics device 14d. In such case, if the thief steals the device 14d, the device 14d may be inoperable without the base station 12 (that would not be available to the thief). For example, the base station 12 may be hidden within the walls of the user's home or otherwise concealed.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
sending a wireless signal to a wireless device;
determining whether the wireless device transmits any wireless transmission responsive to said signal; and
if no wireless transmission is received from said wireless device in response to said wireless signal, disabling an operation of said wireless device.

2. The method of claim 1 wherein sending a wireless signal includes sending a range limited wireless protocol signal.

3. The method of claim 2 wherein sending a wireless signal includes sending a Bluetooth protocol signal.

4. The method of claim 1 including rendering said wireless device inoperative if no wireless response is received from said wireless device.

5. A non-transitory computer readable medium storing instructions executed by a computer to:
send a wireless signal to a wireless device;
determine whether the wireless device transmits any wireless transmission responsive to said signal; and
if no wireless transmission is received from said wireless device in response to said wireless signal, disabling an operation of said wireless device.

6. The medium of claim 5 further storing instructions to send a range limited wireless protocol signal.

7. The medium of claim 6 further storing instructions to send a Bluetooth protocol signal.

8. The medium of claim 5 further storing instructions to render said wireless device inoperative if no wireless response is received from said wireless device.

9. An apparatus comprising:
a wireless transmitter to transmit a wireless signal to a wireless device; and
a processor coupled to said transmitter to determine whether the wireless device transmits any wireless transmission responsive to said signal and if no wireless transmission is received from said wireless device in response to said wireless signal, said processor to disable an operation of said wireless device.

10. The apparatus of claim 9 wherein said transmitter is a range limited wireless protocol transmitter.

11. The apparatus of claim 10 wherein said transmitter is a Bluetooth protocol transmitter.

12. The apparatus of claim 9, said apparatus to render said wireless device inoperative if no wireless response is received from said wireless device.
